(19) United States
(12) Patent Application Publication
(10) Pub. No.: US 2002/0029164 A1
(43) Pub. Date: Mar. 7, 2002

(54) Parking management system

(76) Inventors: Michael M. Sugar, Tarzana, CA (US); Alan Rice, Tarzana, CA (US); Paul Stevenson, Tarzana, CA (US)

Correspondence Address: COLIN P ABRAHAMS, 5850 CANOGA AVENUE, SUITE 400, WOODLAND HILLS, CA, 91367

(21) Appl. No.: 09/728,067

(22) Filed: Dec. 1, 2000

Related U.S. Application Data
(60) Provisional application No. 60/168,325, filed on Dec. 1, 1999.

(51) Int. Cl. G06F 17/60

(52) U.S. Cl. 705/13; 705/5

(57) ABSTRACT

A method for electronically reserving a parking space at a parking facility through a computer network comprises the step of accessing by a user communication with a server computer on the computer network, the server computer operating a program for reserving a parking space at a parking facility and containing data relating to a plurality of parking facilities. Thereafter, the user identifies a parking facility and the time for which a parking space is required in the parking facility, and reserves the parking space in the parking facility. Payment is effected for the parking space by providing information to enable the server computer to directly or indirectly transfer funds for the parking reservation from a user designated payment source to target account. Then, confirmation from the server computer is received that the parking reservation has been made.

### CROSS REFERENCE TO RELATED APPLICATIONS

This application claims the benefit of U.S. Provisional application No. 60/168,325 filed Dec. 1, 1999. This provisional application is incorporated herein in its entirety.

### FIELD AND BACKGROUND OF THE INVENTION

The administration and management of parking facilities in many different contexts has become a major factor in the economic life and commerce. For the millions of people who travel to various locations by car or other vehicle, the issue of finding and obtaining suitable parking invariably arises. Thus, for example, workers traveling to a place of employment will need to park their vehicles during working hours, and many employers provide reserved or unreserved parking spaces for their workers as a job benefit. Further, travelers commuting into the city or densely populated areas require parking spaces for their vehicles while carrying out their activities. Users of airports, attendees at sports events, concert and theater goers, as well as shoppers in certain areas are just a few of the examples where the provision and control of parking facilities is an ongoing issue.

In conventional use, parking structures or areas are demarcated as adjacent to, or part of, buildings, stadiums and the like, and have entry and exit gates for drivers of vehicles to enter and park while attending the specific activity or event. It is fairly typical for the entry gate to be manned by one or more, sometimes many, parking attendants, and the vehicle user waits in line at the entry gate, eventually reaching the parking attendant. At this point, payment is made, or a ticket is issued, and the vehicle operator enters the lot or structure to park. If payment is not made in advance, further lines may be encountered at the parking lot exit gates, where payment based on the length of time for which the facility was used is made.

The current systems have many inherent disadvantages. One, of course, is delay while manned operators have to process each request, which may be customized and vary from one user to the next. Another issue is knowledge of parking lots themselves, and where a user can park. These may be difficult to find, and if indeed located, may be full or otherwise unavailable for the user at the relevant time. Another inherent disadvantage of this manual system of parking reservation and control is a lack of security. Relatively large amounts of money may be taken by the parking attendant, raising the risk of robbery or attack. Further, parking users have to count out exact amounts of money, or may not even have the precise change, further slowing the system.

Conventional systems are also labor intensive, requiring a large number of parking attendants, often at both the entry and exit gates, making the system expensive to operate and subjecting it to many types of delays and inefficiencies.

The problems associated with existing parking systems may be particularly acute in managing parking facilities in large office buildings. A very substantial number of workers or employees may drive in and out of the building each day. There is a constantly changing profile of users, with new users being added all the time, and existing users being deleted from the system. There is also a significant amount of input with respect to vehicle identification, currency of payment for monthly parkers, and other data which may be relevant to the parking facility.

Another disadvantage of existing systems where office or commercial parking facilities are used is the difficulty and delay in tracking payment. A particular company (or tenant) within an office building may delay payment, and there may well be a time delay before employees of that company may be barred from entering the facility due to lack of payment, until the payment issue has been rectified.

The current systems of managing parking facilities therefore are lacking in many respects, leading to inefficiencies and ineffective control. It would therefore be advantageous to institute a system which significantly streamlines parking facility management, reduces labor intensive tasks, and monitors users, vehicles, and payments on a thoroughly up-to-the-minute system, so that the building owner, parking controller and other interested parties can maximize use as well as the efficiency of parking facilities.

### SUMMARY OF THE INVENTION

According to one aspect of the invention, there is provided a method for electronically reserving a parking space at a parking facility through a computer network, the method comprising the steps of: accessing by a user communication with a server computer on the computer network, the server computer operating a program for reserving a parking space at a parking facility and containing data relating to a plurality of parking facilities; identifying a parking facility and the time for which a parking space is required in the parking facility; reserving the parking space in the parking facility; effecting payment for the parking space by providing information to enable the server computer to directly or indirectly transfer funds for the parking reservation from a user designated payment source to target account; and receiving confirmation from the server computer that the parking reservation has been made.

According to another aspect of the invention, there is provided a computer based parking reservation system for making parking reservations through use of a computer network, the system comprising: a server computer on the computer network for operating a parking reservation program and containing data relating to parking facilities and users thereof; means within the server computer for receiving and processing data received from users through computers in the computer network relating to a parking space to be reserved at a parking facility at a selected time; means for transferring funds from an account designated by the user to a target account of a parking facility operator; and means for generating a confirmation message to the user relating to the parking reservation.

The invention is for a parking management system which enables the various users thereof to designate parking facilities, reserve parking spaces, monitor usage of the parking facilities, and to obtain information as to he status of the entire system, using Internet-based reservation and payment systems, updating and the like. The Internet is used herein to refer to a vast computer network, accessible by users through a dial up connection, the network including “servers” which are computers running within the computer network and operating programs and software which can be used by “clients” or “users”. “Users” refer to workstations, PC computers or other devices connected to the computer network through telephone or other access lines.

The parking management system of the invention also operates when used electronically, such as by communications between computers, whether through the Internet, dedicated phone or other lines, or other avenues for transferring information between computers.

The invention is for a parking management system that allows members of the general public to pay parking fees over the Internet, or electronically between computers such as those connected by modem. The invention has many varying applications, including but not limited to uses in the commercial office building industry. Other applications allow the general public the ability to purchase and reserve event, airport and city parking over the Internet or electronically, in advance.

Unlike other electronic or Internet systems for parking reservation, the invention is not just a retail focused e-commerce business. The invention is a multi-dimensional platform that not only allows for parking purchases, but provides parking operators and property managers the ability to download or electronically transfer financial information into given accounting or data base management software systems. The invention therefore takes commercial service to the next step in e-commerce business tools.

In one aspect, when a commercial property owner uses the features and applications of the present invention, the tenants of the property using the parking facility thereof may have no choice but to make payment electronically or via the web site, upon which the invention will be operated. The benefits derived from the invention by property owners include improved cash flow, significantly reduced administrative costs, better data base information and improved service quality. The invention permits generation of revenues from parking purchases, transaction fees, software sales, web-site advertising and high-end demographic list sales.

There is currently no known service on the market in any way comparable to the present invention. Property owners and parking operators are looking for ways to reduce cost in an industry that handles, according to some estimates, as much as $26 billion in annual revenues. The invention has as its primary targets large portfolios of A and B+ commercial office buildings, the majority of which are located in the major cities in the United States. This business to business clearly fills an identified need in streamlining parking management in all its aspects and provides a product for use in a unique niche.

### BRIEF DESCRIPTION OF THE DRAWINGS

FIG. 1 of the drawings is a schematic diagram illustrating the various levels of computers operating within the method of the invention, showing also the various levels of access by different parties or entities to a particular computer;

FIG. 2 is a flow chart illustrating initial user access to the system, including various options available as to the nature of parking space or spaces required;

FIG. 3 is a flow chart showing use of the method of the invention by users requiring parking spaces for specific purposes;

FIG. 4 is a flow chart showing use of the method of the invention by, for example, the management of an office building using the system for review and maintenance purposes;

FIG. 5 is a flow chart showing use of the method of the invention by a parking operator indicating the various uses and reviews available;

FIG. 6 is a flow chart showing use of the method of the invention by the overall program operator and manager showing uses available for review, maintenance, update and the like;

FIG. 7 shows illustratively the various methods of connection between different computer systems, and different forms of access for obtaining information, updating the system as well as miscellaneous links within the system; and

FIG. 8 is a detailed flow chart of the system of the invention showing in further detail some of the parameters and data which various systems may handle.

### DETAILED DESCRIPTION OF THE PREFERRED EMBODIMENTS

The invention is for a parking reservation and management system which is substantially handled through users of the system by inputting various forms of data at different computers, all of which are processed by software on a server computer. Thus, an end user using a personal or office computer may access the server software and input data as to parking space required, date and times thereof, particulars of individual and vehicle, and other specific information, as discussed below. The system is also accessible to building management of an office block in which a parking facility is located to obtain information relating to that parking facility. Further, the system is also accessible to parking operators operating one or a multitude of parking facilities so as to obtain information thereon, update such information, and manage the entire system. Further still, the system is operated and controlled by the overall program operator, which is able to access and input information on all levels, as well as to make changes to the software programming to improve or update the system software, as required.

Two representative examples showing the use of such methods of the invention are set forth below.

### EXAMPLE 1

### Commercial Office Building Parking

The invention offers an interactive web-site that allows for reservation of parking spaces and payment of parking fees for such reservations over the Internet. This service may be marketed to owners and managers of commercial office buildings, but at the same time offers a service to a tenant (also a user or customer) in the form of a payment or revenue collection service. Office building tenants who purchase monthly parking passes may be required to make their parking purchases electronically or over the Internet, for example at a web-site where the system software of the invention is located. The web-site, with a simple and easy to use format, allows the tenants to add or delete parking passes and make changes to their purchases, depending on the specific requirements of the tenant at a particular time. The site requires tenants to update data related to any changes.

The web-site in turn provides the parking management and the building owners with real time data on the tenants that are currently using the parking facility. Some of the primary benefits which may be derived by the parking management companies and building owners utilizing the invention include lower administrative costs, improved cash flow and better data management. The lower administrative costs are achieved by putting the burden of data input back on the tenant, thus eliminating the need for a billing and collections function. Cash flow is improved by the purchase transactions being directly deposited into the building management's bank account. Parking facility operators often collect and hold payments for up to 45 days before remitting proceeds to the property management. Finally, the quality of the user information is improved as the parking attendants can verify each parking reservation or parking space purchased. The reservation system of the invention may include direct links to the parking facility access equipment, enhancing control over the facility. For example, key cards may be shut off or invalidated when payments are not made by a given date. Such shut off may preferably be automatically activated when a payment has not been made for use of a parking space by a tenant. This essentially creates a completely automated access control system that requires no human input. This has the effect of “depersonalizing” the system, making it very difficult for parking space users to request further time for payment, or to delay payment for non-related reasons.

### EXAMPLE 2

### Selling Parking to the General Public

Another aspect of the invention relates to its application in the selling of event, airport, city and other types of parking to the general public via an Internet web-site or other electronic path. Example: A person is given tickets to a basketball game and that person does not have a parking at the ball game venue. The parking management system of the invention allows the person to log on to the Internet web-site, pay and reserve parking space(s) at the event venue before attending. Upon making a reservation on the web-site, the person is sent an e-mail or confirmation with a special access code. When the customer arrives at the game venue to attend the event, he/she uses, for example, a special gate with a keypad that will accept a personal or special access code provided when the reservation was made on the web-site. The reservation system of the invention thus allows for the elimination of an attendant at the gate, or at least at certain designated gates, and permits the event management to collect parking fees in advance. It also takes the cash out of the hand of the on-site parking attendants, which is itself a major benefit from a security perspective.

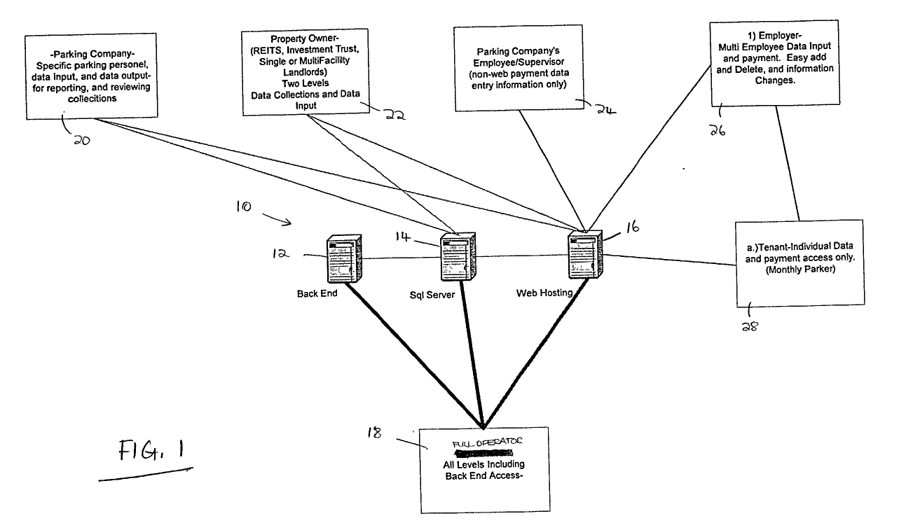

Reference is now made to FIG. 1 of the drawings, which shows in schematic form a communication diagram indicting the broad features of the invention, as well as accessability by certain entities to various aspects of the system. In FIG. 1, there is shown a schematic representation of the various parts and levels of computer which may be incorporated into the system, and the access to each computer available to end users, operators, as well as the full system operator, which is the designer of the software and programing for running the parking reservation system of the invention. FIG. 1 shows a computer bank 10 including a full operator computer 12, an operator computer 14, and an end user computer 16. Although, in FIG. 1 of the drawings, these computers 12, 14 and 16 are shown in close proximity to each other, they may, in fact, be located apart from each other, and usually in different locations or remote areas.

The full operator computer 12 has very limited access, and only the full operator of the parking reservation system of the invention would have access to this computer 12. The full operator 12 computer contains the necessary programming and software for running the system, and any amendments, modifications, updates or changes to the software or programming of the parking reservation system of the invention will be made at this computer 12.

The operator computer 14 will typically be accessible to the full operator, as well as specific parking operators and parking facility property owners. In this regard, the parking facility property owner would, of course, be the entity who actually owns the facility, while the parking operator may be a management organization retained by the owner to administer the parking facility, including allotment of parking spaces, collection of fees, and general daily operations. All of these entities would have access to the operator computer 14, and would be able to record and obtain information relating to a particular facility or group of facilities, as will be described more fully below.

Lastly, FIG. 1 shows an end user computer 16 which would be accessible to all the users of computers 12 and 14 already described above, and additionally accessible to end users such as employee, employer, tenant, monthly parker, one-time parker, and the like, in any combination as may be desired or appropriate.

Reference is now made to the text boxes in FIG. 1, with box 18 indicating that the full operator has access to all computers, and all levels. Box 20 defines the parking company, including specific parking personal, which input data into the system, review data reports from the system, and keep track of collections, this entity having access to both the operator computer 14 and end user computer 16.

Box 22 shows the access of a property owner, such as an investment trust, single- or multi-facility landlord, having access also to operator computer 14 and end user computer 16. Such entities would be capable of obtaining data on collections, payments and other money-related issues, and also have the ability to input data into the system.

Box 24 indicates the type of access which an employee or supervisor of a parking company may obtain into the system. Such an employee or supervisor would typically only have access to end-user computer 16, and be provided with information already entered so as to be able to obtain information as to the particular status of one or a group of parking spaces or facilities. Such an individual would not have access to any more or less information than that available to the end-user, although certain personal information may be excluded.

With reference to box 26, there is shown the access available to an employer having multiple employees, each or some of which may be using parking spaces within a particular facility. Such an employer would be able to input data directly into the system, such as new employees, including name, vehicle details, and other pertinent information, and also to delete information on former employees, change of vehicle, and type of parking (for example, reserved or unreserved) required.

Box 28 also shows access by an end-user to the end-user computer 16, the box 28 relating to monthly parkers, and the ability to make payments, most typically by credit card, according to the number of parking spaces reserved, the types thereof, and other information which has been entered.

As will be appreciated from the diagrammatic representation in FIG. 1, only the end-user computer 16 provides access to all entities. On the other hand, the full operator computer 12 has very limited access, and only to the overall system operator and administrator, while the operator computer 14 has somewhat restricted access, only to those on a need-to-know basis. In all situations, passwords or security clearances measures would have to be obtained to either enter the system, or once in the system, to gain access to specific files or references of information therein.

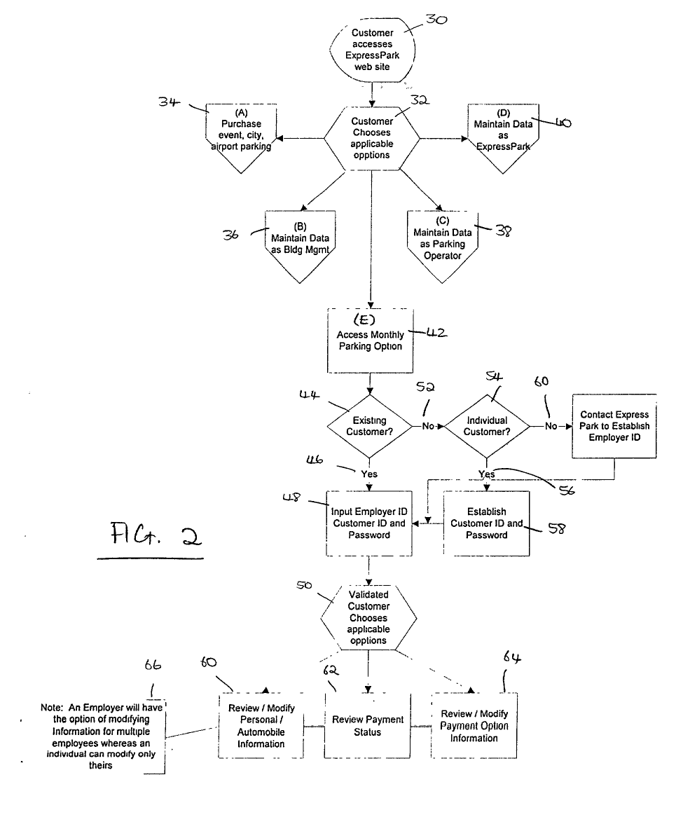

Reference is now made to FIG. 2 of the drawings, which is a flow-chart illustrating initial options to a customer-user of the system of the invention. It will be appreciated that the customer represents a person, or a group of persons, such as employees of a company who wish to make parking reservations on a one-time or on a continuing basis, as well as updates as to the status of users and other essential information. Initially, the customer logs on to a website, and gains access, either directly with an existing password, or as a new user to the system without a password. As will be seen in box 30 in the flow-chart of FIG. 2, a customer accesses the end-user computer, such as an end-user computer 16 illustrated in FIG. 1, of the parking reservation system of the invention. Upon gaining access to the appropriate website, the customer is faced with certain options, as shown by box 32 in the flow-chart. These options are as follows:

Option A, as shown in box 34 is intended for a single-time user who wishes to reserve and purchase a parking space such as at a concert or sporting event, a city parking lot, an airport parking lot or the like;

Option B, as shown in box 36, is available for building management, or the owner of a parking facility, in order to input information, or to obtain data from the system regarding the status of one or more facilities;

Option C, as indicated by box 38, is accessible by the parking operator, to maintain data, update data, review information or the like;

Option D, as indicated by box 40, is used by the full operator of the system, and is used to secure full access, after appropriate security and identification procedures have been completed, to the software, application programming and the like, in order to have all forms of access to the system, as well as the ability to amend or modify the system software;

Option E, as indicated in box 42, provides access to monthly parking options. Option E would typically be used by employers, or others handling parking reservations on an ongoing basis for multiple users, wherein the system requires addition of new users, deletion of existing users, updating regarding vehicle changes, changes regarding type of parking required (such as reserved or unreserved), or other pertinent details that may be relevant to the parking reservation.

As will be noted from the flow chart in FIG. 2 of the drawings, the various steps and procedures available to users of the parking reservation system who wish to establish, modify or otherwise change monthly parking options from, for example, a commercial office facility, can be seen. The user selects the option for the access monthly parking, as indicated in box 42, and is then prompted to indicate whether the customer is an existing one, as set forth in box 44. If the customer has established prior user rights with the system, a “yes” 46 is entered into the system, and the user, as indicated in box 48, is prompted to enter some form of identification, such as the employer identification, customer identification number and/or a password. Once an acceptable identification or password has been entered into the system, the user is authenticated as a validated customer, as shown in box 50, and is provided with additional options for proceeding.

The user may indicate, in box 44, that he is not an existing customer, by prompting the system with a “no” 52, and is then asked if he is an individual customer, as in box 44. If a “yes” 56 is entered into the system, the user is directed to box 58, where customer ID and a password is established. This is achieved by the customer providing predetermined information, including, but not limited to name, address, contact information, e-mail addresses, number of parking spaces required, and the type thereof, the building or facility where the parking space is required, the number of vehicles, the identification of vehicles, and other such pertinent information, some of which is discussed below. If the customer indicates by a “no” 60 that it is not an individual, one option would be to contact the full operator to establish a special employer ID, and be provided with the appropriate identification and password numbers. In such case, the operator handling the transaction may wish to check issues such as the potential user's credit-worthiness, as may be customary in the industry, and, once done, award the user the necessary security data to ensure access to the system for later transactions. It will be noted, where the customer is an individual, and establishes identification as set forth in box 58, such ID may be established by including details relating to existing credit card accounts from which payment for reserved spaces may be debited for the present and subsequent transactions.

One way or another, with existing users, or new users having established appropriate credit and having been accorded the necessary password information, the customer arrives at the various options as indicated in box 50, for further proceeding with transactions. Three options may, in the particular embodiment shown in the flow-chart of FIG. 2, be presented to the customer. The first option is one to review, modify or otherwise change or update information, as set forth in option box 60. Another option, as shown in box 62, is to review payment status, including a determination of what payments have been made for particular periods, which parking spaces have been reserved, and for how long. The third option, shown in box 64, gives the user the opportunity to review payment options available, and to modify them according to current needs or requirements. Generally, payment can be effected through use of a credit card, or through online banking transactions, whereby a user, by inputting the necessary data, authorizes, for example, the operator to immediately debit a pre-authorized checking or banking account, so as to ensure the immediate transfer of funds from the user to the operator for payment, preferably in advance, of the parking spaces reserved.

Box 60, in FIG. 2, is particularly important, since it enables the user to input all the relevant information for reservation of a block (or plurality of parking spaces) in a particular facility. The types of information which would be inputted by the user include, but is not limited to, the following: i) name and address of employer, ii) name or identification of parking facility, iii) number of spaces required, iv) name of each individual for whom a parking space is required, v) details of vehicle of each individual for whom a parking space is required, vi) the period (typically a calendar month) for which the parking space is required, and vii) the type of parking space required, such as reserved, unreserved, covered, uncovered, or such other as may be available.

This option also gives the user the opportunity to modify previously inputted information. For example, it is possible that when a new employee parking space user requires a space, the system will be updated, after the employer or user has been appropriately identified and the password information inputted, by adding the name of the user, vehicle information, parking space information, and the like.

For a particular building or parking facility, the system software or programing will have an assigned value for a particular space. Thus, if a particular reserved parking space is required in a building for a period of one month, a current rate of “x” dollars will be inputted into the system. This information can, of course, be changed from time to time, according to fluctuations in prices for parking spaces and facilities, and is typically information which may be inputted in the system by the property owner or parking operator company. In any event, with this information in the system, the user is provided with immediate feedback as to the costs of the reservation for one or more parking spaces of the type designated and described and inputted into the system. For example, the user will be given a total dollar amount for a certain number of parking spaces for the forthcoming month, and the user, upon approval, would make the necessary authorizations online to pay the amount, either by credit card, or appropriate bank transfer from an account which has been authorized by the property and parking facility operator.

As shown in box 66 in the flow chart of FIG. 2, an employee may have somewhat broader access rights to the system, which would include the option of modifying information for multiple employees or parking space users. On the other hand, an individual reserving a parking space, even on a monthly basis, would have only security and access privileges which would enable him to modify, and/or delete from his own single file of information.

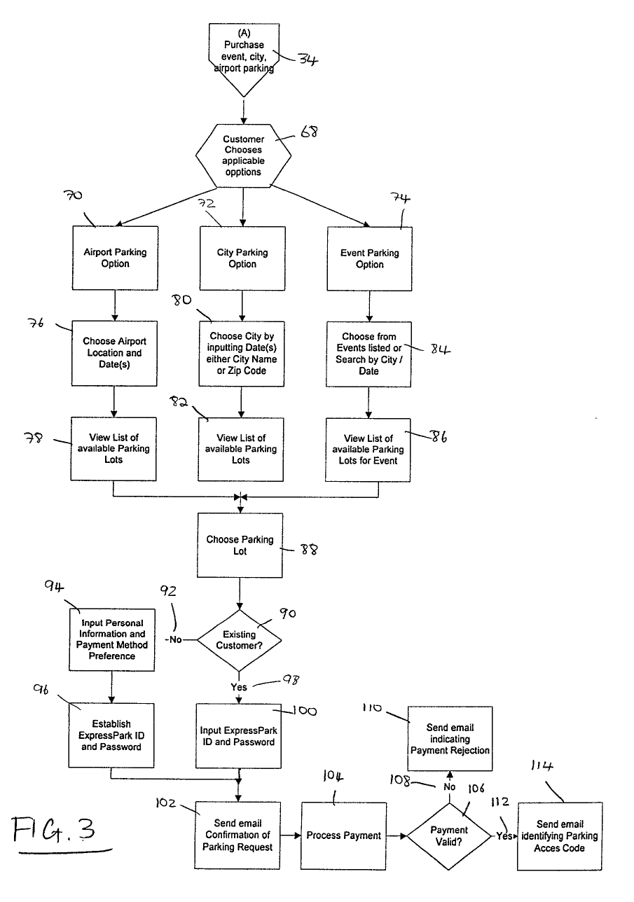

Reference is now made to FIG. 3 of the drawings. FIG. 3 illustrates the further steps available to a user who has selected option A identified in box 34 in FIG. 2 of the drawings. Option A provides the user the ability to a reserve parking spaces at an event, such as one at a sports stadium, theater or concert hall, or to obtain a reservation at a city parking lot or airport parking facility. Upon selecting option A, indicated by box 34, the user is directed to an option screen, as indicated in box 68, and in the embodiment illustrated in FIG. 3, three different options are provided. In FIG. 3, the options available to the customer include reservation of parking at an airport facility, as indicated in box 70, reserving a city parking space as indicated in box 72, and reserving an event parking space, as indicated in box 74. It will be appreciated that, although three different options are given in the example of the flow chart of FIG. 3, any number of variations where parking is essentially reserved on a one-time basis, for a given time, may be included in this example. However, it is foreseen that the three options provided in the flow-chart of FIG. 3 cover a substantial portion of the relevant number of choices or situations likely to occur on an ongoing basis.

In box 70, if the airport option is selected, the user is then prompted to indicate the particular airport where a parking space is required, and the dates for which such space is required (see box 76). The user would, as shown in box 78, be provided with a view or list of available parking lots, information as to such parking lots, such as proximity, cost, whether long- or short-term, availability of airport transport between the lot and airport terminals, and such other information as may be relevant.

If the city parking option 72 is selected, box 80 shows that the user is prompted to indicate the city, for example, by city name or zip code, and can thereafter view available parking lots, as indicated in box 82, before proceeding. Once more, the system may provide the user with certain information regarding the parking lot, including proximity to a particular site, cost, security arrangements, access routes to the lot, and such other information as may be appropriate under the circumstances.

The third option available to the user is the selection of the event parking option, as shown in box 74, from which the user is prompted to box 84 and asked to choose from a series of events listed. These events may be listed alphabetically, according to the city, the date of the event, the player, artist, team, etc. Once the user has identified the particular event for which a parking reservation is required, he is taken to box 86 to view a list of available parking lots for the events, including information related to proximity of the parking lot to the event, cost thereof, and other particulars already discussed with reference to the two previously mentioned options.

Once the user has gone through the various steps according to the airport, city parking, or event parking selected, the user eventually arrives at box 88, and makes a final selection of the parking required, including such particulars as the dates required, number of spaces required, even times required where applicable. The user may also be required to provide information as to the vehicle particulars, since the lot may have assigned smaller spaces for smaller and compact vehicles, while bigger spaces are provided for vans, SUVs and other types of larger vehicles.

With the selection of the parking lot, dates and other particulars complete, the user is prompted to the next screen, indicated by box 90, in which the user is requested to indicate whether he is an existing customer. If “no” 92 is entered, the user is prompted to a screen, represented by the box 94, requesting that certain personal information and payment method preferences be inserted. Most typically, the user would provide his name, and an existing credit card number and expiry date thereof. The system software would be programmed to check the validity and status of the card, and once approved, the user would be provided with a particular identification number and/or password, as indicated in box 96. It will be appreciated that this identification number may be used in future transactions, since the insertion of the identification number in future situations would identify the user and avoid the necessity of repeating various entries each time a parking space reservation is required.

If, in screen 90, the user indicates a “yes” 98, he would be requested to input identification numbers and passwords, as shown in box 100, which the system would process and approve if previously authorized and in good standing.

Whether a newly established customer with data inputted by route 92, 94 and 96, or a previously existing customer once more approved via route 98 and 100, the user would access a screen as shown in box 102, which, in the embodiment shown in FIG. 3, would constitute an e-mail confirmation by the system, summarizing the specifics of the reservation for the user's review. If there was some error or change to be made, an opportunity at this point would be provided to the user so that the correct and proper reservation was made. When all the particulars relating to the customer, reservation space, dates and the like, are correct, the user authorizes the transaction, and is directed to screen 104 where payment processing is initiated. One of the pieces of information that the user would be required to approve would, of course, be the cost of the reservation, as indicated in screen 102. With the user's approval, the system would debit the user's credit card, and the validity of the financial transaction in payment for the parking space reservation would be indicated as valid or invalid, as shown in box 106. If the validity of the payment is shown as a “no” 108, the user would be advised, either on the existing screen, or in a subsequent e-mail, that payment was rejected, as shown in box 110. If, on the other hand, the validity of the financial transaction was approved by a “yes” 112, the user would, as shown in box 114, receive notification confirming the sale of the parking reservation, providing all identifying data, and further providing the user with an access code which would be used to gain entry to the parking lot where reservation was made. The access code may be in the form a print-out, or an alpha-numeric code which may be entered onto a keypad at the parking lot entry, thereby opening any boom or gate, allowing the user entry into the parking lot. Upon entering the various access information, the system would, of course, check the reservation information to ensure that the user has arrived at the correct date and time, and at the correct lot, and if all the circumstances correspond to the reserved data information, user access will be initiated.

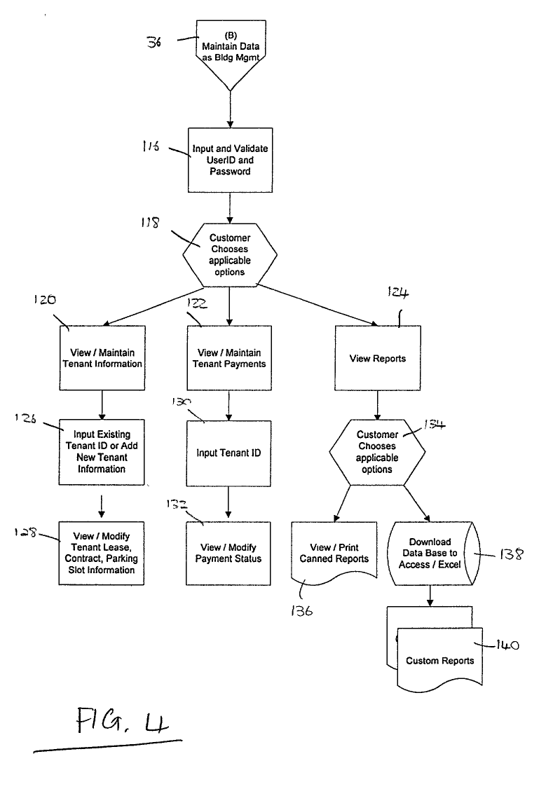

Reference is now made to FIG. 4 of the drawings, which shows the various steps and options available when the customer selects Option B as indicated in the flow chart of FIG. 2. Option B, as indicated by box 36, represents the various steps, procedures, and accessability to building management regarding any of its parking facilities. Upon selecting the Option B, thus identifying the user as building management either requesting further information or requiring updating of information as to a particular parking facility, the user is prompted to a screen indicated by box 116, where the user is asked to input and validate its user ID and password. Upon appropriate authorization, and approval by the system that the management is entitled to the information, the user is directed to a screen indicated by box 118, where the customer is provided with three options, one of which may be selected.

The first option selectable by the user is indicated in box 120, for the view of tenant information, and, upon selection of this option, the user is transported to a screen represented by box 126. At this point, the user must either identify a particular tenant for which specific information is required, or add information regarding a new tenant recently signed up and requiring parking space reservation. Whether with an existing tenant or a new tenant, once identified, the user is moved to a screen represented by box 128, wherein the user will be provided with appropriate access to the tenant lease, the contract with the tenant, slot information regarding the parking spaces, cost of parking spaces, number and usage. At this point, the building management will also have the option of modifying certain information, for example, reassignment of parking spaces, modification of Lease Agreements, changes relating to the cost of the parking on a daily, weekly or monthly basis, as desired.

Another option available to the user representing building management is to view the system insofar as it relates to tenant payments. This is shown by box 122. When this option is selected, the user is moved to a screen represented by box 130, where, once more, the particular tenant identification particulars should be inserted. Once done, the user will then have access to the file of that tenant insofar as it relates to the parking facility. Payment status, including amount paid, date of last payment, any unpaid amounts, or overpayments, may be viewed on a screen, as indicated in box 132.

The user may also choose simply to view and/or print certain reports, as shown by the option in box 124. In this situation, the user or customer chooses applicable options, such as building, parking facility, parking lot, tenants or group of tenants, or such other combination as may be desired. These reports may be either viewed and printed from the screen and directly from the program, as indicated in box 136. Alternately, the information may be downloaded to the building management's own computers and software, as indicated in box 138. Thereafter, the information may be manipulated, sorted or processed in the manner desired by the building management, so that custom reports 140 are generated according to the needs and requirements of the building management.

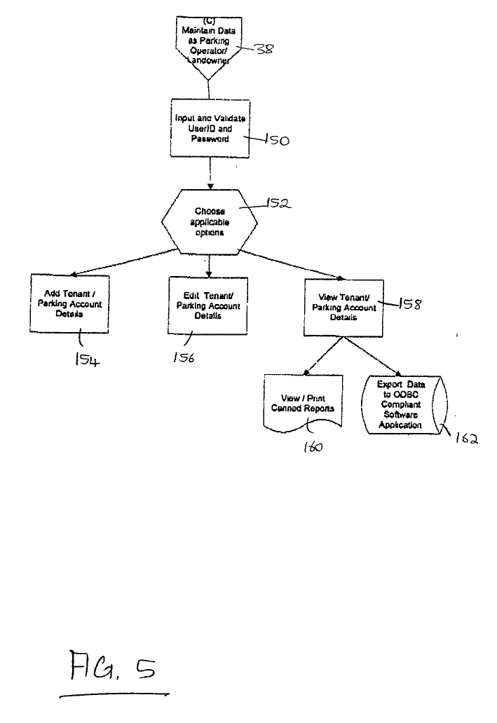

Reference is now made to FIG. 5 of the drawings. In FIG. 5, further procedures and options available to a customer or user who has selected option C, from box 38, are provided. This box should be selected by the parking operator in order to gain access to the system for various purposes as will be described below. Upon selecting option C, the system prompts the parking operator or landowner seeking information on the system to input and validate it's user ID and password, as indicated in box 150, to secure further access to information on the system. With this authorization, the user is prompted to a screen, and invited to choose available options, as noted in box 152. These options include: the ability to add a tenant and tenant information, as well as parking account details thereof, to the system, shown in box 154; calling up specific tenant information and editing that information, as well as obtaining parking account details relating to that tenant, as indicated in box 156; and to generally view tenant information and parking account details relating to that tenant, as indicated in box 158. In the last mentioned option, the parking operator or landowner can simply view the information with the option to print reports based on the view, indicated in box 160, or download it or export the data to its own computers which have compliant software applications, as indicated in box 162. With the information downloaded, the data can be sorted, or otherwise worked with to obtain the necessary reports, presented in the desired format.

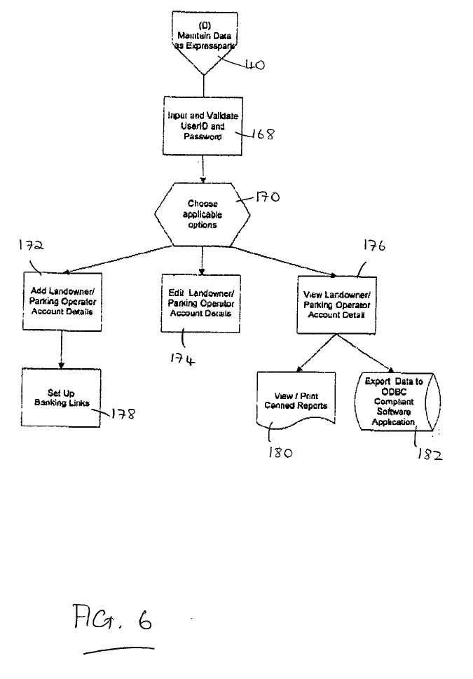

Reference is now made to FIG. 6 of the drawings, which is a flow chart illustrating the options available when option D from FIG. 2 is selected. Option D is the access provided to the full operator, namely, the operator having full access to all aspects of the parking reservation system of the invention, including the ability to update the software applications, with access to source and object codes for the purposes of modifying or otherwise changing the software. Upon selecting option D, indicated by box 40, the full operator is invited to insert and input it's user ID and password, which is thereafter validated, as indicated in box 168. The full operator is prompted to a screen including certain options available, indicated in box 170. The options available to the full operator, as indicated in the embodiment shown in FIG. 6, include: the ability to add a landowner or parking operator, with account details, as shown in box 172; edit information relating to a particular landowner or parking operator, and view and maintain data related to the parking details, as indicated in box 174; and generally view landowner and parking operator information and account details as indicated in box 176.

With respect to the option available shown in box 172, when adding a new landowner or parking operator to the system, a series of steps is available to set up banking links, shown in box 178. This includes obtaining banking information and credit details from the new landowner or parking operator which are then entered into the system, carrying our appropriate credit-worthiness checks, verifying bank information, and setting up the necessary links between the system and the landowner/parking operator's bank accounts to facilitate the transfer of funds electronically between the new account's bank and the appropriate operator's bank.

With respect to the general review of landowners and account details, shown in box 176, this information can simply be viewed, and the viewed information printed, shown in box 180, or the information can be downloaded to the full operator's computer drives, which would include compliant software applications, as shown in box 182. Once downloaded, the information can be retained, or it can be sorted, for presentation in desirable formats.

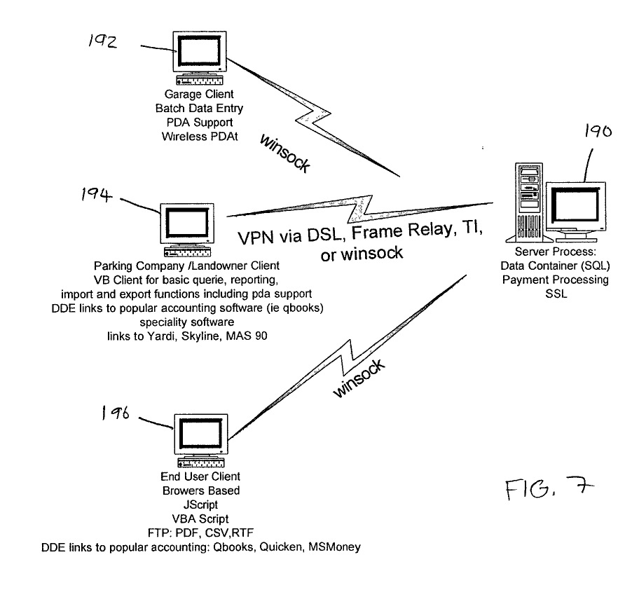

With reference to FIG. 7 of the drawings, there is shown another embodiment of the invention showing different forms of access, types of connection, compatible software and possible links offered by the parking reservation system of the invention. In FIG. 7, a server computer 190 is accessible from different computers including garage client computer 192, the parking company or landowner client computer 194, as well as the end-user client computer 196. Details relating to these types of users, as well as the information which they may wish to obtain or manipulate in the system, and various restrictions with respect to each, have already been described above. It will be noted that all computers 192, 194 and 196 are shown in this embodiment as having a winsock connection. Additionally, the parking company or landowner client computer 194 may have access through other forms of connection, such as VPN via DSL, frame relay, TI, in addition to winsock.

The main or server computer 190 includes all the data and payment processing capabilities, different aspects or which are available to different users depending on their level access to the system. With respect to the garage-client computer 192, this computer would be capable of batch-data entry, PDA support, and wireless PDAt.

The parking company or landowner-client computer 194 would have access through the various connections to make certain basic client queries, insert reporting information, as well as the importation and exportation of functions including PDA support. Links would also be provided to conventionally and commonly available accounting software, and possibly to other specialty software, so that the data in the system can be used with that software for sorting, merging, or presentation in desired form.

The end-user-client computer 196 also has access to the system, and DDE links to popular accounting software such as, for example, Qbooks, Quicken, MS Money or the like, would be possible in order to create the necessary reports desired by the specific user.

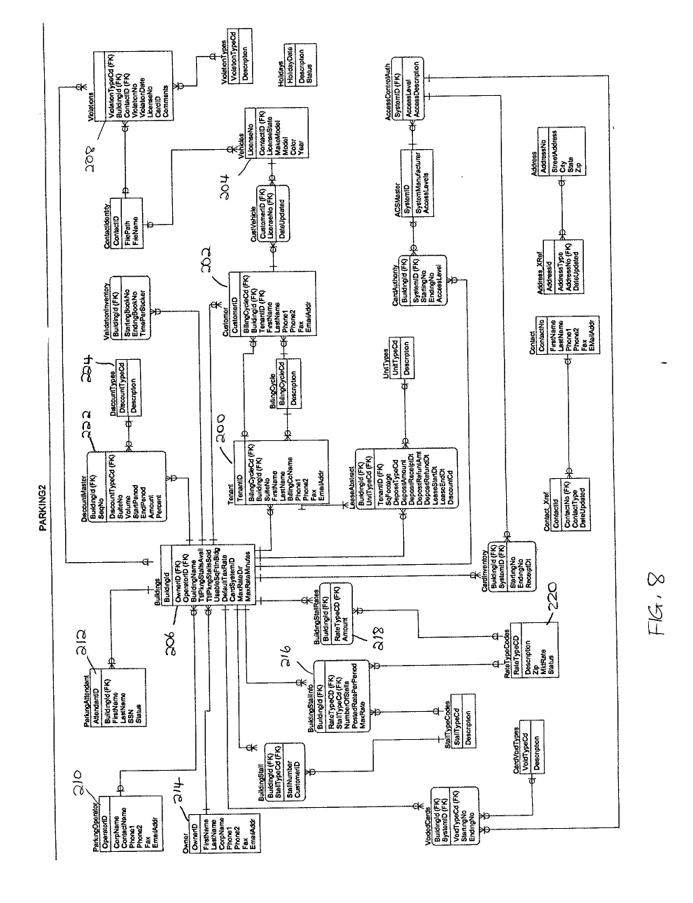

With reference to FIG. 8 of the drawings, there is illustrated a much more detailed flow chart containing the flow paths, and boxes indicating in considerable detail the various pieces of data and information which may be required by the system, or which may be inputted into the system, and from which records may be created. For example, box 200 recites certain data relating to an office block tenant, which may be required, such as: the billing cycle, the name of the building, suite number, full names of users, the name of the company to be billed, various phone, and fax and e-mail contact information. For a specific customer, as indicated in box 202, information may comprise: billing cycle, building identification, tenant identification, various names, phone, fax and e-mail numbers and addresses. Box 204 provides information as to the vehicles for which parking spaces are reserved, including contact identification, state and license number, make, model, color and year.

Restricted access may be given to certain parking operators, and the full operators, as to buildings on the system and the details thereof as indicated box 206. Information as to such buildings would include the owner identification, the parking operator identification, the building name, the total number of parking stalls available, the total number of parking stalls which have been sold, the useable area available in the building, tax rates, the car system identification, and various rates as to parking spaces, including direct rates and time rates.

The system may also keep track of any violations, as indicated in box 208, such as violation type, the building identification, the contact person, number of violations and the date thereof, the license number of the violator as well as the card identification, and space for any comments.

Appropriate information concerning a parking operator box 210, the parking attendant box 212, and owners 214, would also be recorded in the system.

Boxes 216, 218 and 220 show various options and steps in the system regarding rates, amounts owed, market value, status and other codes relating to payment and value information. Any bulk discounts or other adjustments to payments may also be incorporated into the system, indicated by boxes 222 and 224.

An additional aspect of the reservation system may comprise the implementation of smart card parking passes for city parking facilities. Smart Cards are typically credit card size cards that contain stored information on a micro computer chip or other memory device located on or in the card. The card may be loaded when payments are made to the city in advance. When the customer uses parking facilities at city-parking structures, the access control equipment deducts the fee from the card and changes the amount of parking value stored in the card.

As an example, the following revenue sources and fee rates may be integrated into the parking reservation system of the invention: margin on merchant account charges; transaction fees; set-up charges; monthly services fees; special reporting features charges; web advertising; and list sales. The reservation system of the invention would be of considerable interest to parking operators. The parking industry is condensed at the top and fragmented at the bottom with approximately 1700 commercial operators in the United States.

It is estimated that most, if not all, of businesses located in the target area of this invention, including commercial office space and parking facility providers, and which may benefit from the reservation system of the invention, have access to the Internet or electronic computer-to-computer systems. The remaining tenants who may not have such access may be serviced by having an on-site attendant input the purchase through the parking operators' Internet access.

The reservation system of the invention offers substantial convenience and efficiency to actual and potential users and customers. In this regard it should be noted that the ultimate power to force the use of the reservation system rests with the building owners. If they wish to require all parking pass payments to be made through the parking reservation system, tenant acceptance becomes a moot issue. Notwithstanding the benefits to building owners, the convenience and ease of use which the system of the invention provides to users is likely to be a selling point rather than a hindrance.

In the application of the reservation system of the invention, the customer or tenant is directed to the use of the Internet or electronic system as the way to reserve parking spaces and pay parking bills. Customers will need to use a credit card or cyber check which has been preapproved. This has the advantage for building and parking lot operators that customers will no longer be able to float their charges from one month to the next or park without paying due to human error.

Of course, with the parking reservation system of the invention, payment of parking charges will be easy and quick. Further, changes to purchases and adjusting the invoice will be at the fingertips of the user. The invention will substantially reduce or eliminate the need for paper trails for refunds and new customer applications. All of these procedures and forms will be completed on line. The system results in the issuance of instant parking permits.

In employing the invention, operators would be more comfortable in giving up the float on management trust accounts. Further, the operator may lose total control over the data management. On the other hand, attendant and administrative costs can be significantly reduced. This includes the front-end cost of collections and account location management, and the back-end accounting cost of invoicing, tracking cash collections and receivables management. The system of the invention virtually eliminates all cash payment theft on monthly parking pass revenues, and provides value added service to the building owners and parking customers. The parking attendants and location managers can focus on service without the burden of revenue issues. Another advantage is that operators can be more competitive in terms of management fees and selling their ability to improve cash flow.

The system provides advantages to building owners as well. The system has the potential to: eliminate monthly pass cash payment theft; improve revenue collections; improve cash flow by as much as 45 days; and lower parking management cost. The benefits of the reduced labor cost can be passed along from the parking operator to the building owners, and, ultimately, to the consumer. The invention also facilitates more accurate real-time information on parking tenants.

After any payments, and subsequent to such payments clearing the bank, reconciliation is performed and distribution is made to respective customers.

Further advantages of the parking reservation system of the invention may include: less expensive parking fees; no or reduced waiting in line to park at an event; and flat rate for all day parking in the city.

1. A method for electronically reserving a parking space at a parking facility through a computer network, the method comprising the steps of:
accessing by a user communication with a server computer on the computer network, the server computer operating a program for reserving a parking space at a parking facility and containing data relating to a plurality of parking facilities;
identifying a parking facility and the time for which a parking space is required in the parking facility;
reserving the parking space in the parking facility;
effecting payment for the parking space by providing or identifying information to enable the server computer to directly or indirectly transfer funds for the parking reservation from a user designated payment source to a target account; and
receiving confirmation from the server computer that the parking reservation has been made.

2. A method as claimed in claim 1 wherein the parking facility is selected from the group consisting of: office building, sports stadium, airport, concert or theater.

3. A method as claimed in claim 1 wherein the user accesses from a PC computer.

4. A method as claimed in claim 1 wherein multiple parking spaces are identified in a parking facility and the parking reservation is for an extended period of time.

5. A method as claimed in claim 5 wherein the extended period of time is a one month parking reservation in an office building.

6. A method as claimed in claim 1 wherein reserving the space is carried out by reviewing information provided by the server computer in response to data input by the user and following prompts by the server computer to indicate that information is approved.

7. A method as claimed in claim 1 wherein payment is effected by inputting credit card information to the server computer to enable credit card payment for the reserved parking space by electronic debiting of the credit card account.

8. A method as claimed in claim 1 wherein payment is effected by providing bank account particulars of the user to facilitate electronic transfer of funds between the user designated payment source and the target account.

9. A method as claimed in claim 1 wherein the confirmation received comprises a printout including an access code for entry to the parking facility.

10. A method as claimed in claim 1 further comprising processing security and/or password information to limit access to information to a particular user.

11. A method as claimed in claim 1 further comprising accessing of the server computer by a parking facility owner to receive data relating to a preselected parking facility.

12. A method as claimed in claim 1 further comprising accessing of the server computer by a parking facility operator to receive data relating to a preselected parking facility.

13. A method as claimed in claim 1 further comprising accessing of the server computer by a full system operator to receive data relating to a preselected parking facility, as well as the capability to modify the computer program.

14. A method as claimed in claim 1 wherein different users have different levels of access to the information contained in the server computer.

15. A method as claimed in claim 1 wherein accessing by a user of the server computer is accomplished by means of a modem or high speed connection between the user computer and the server computer.

16. A method as claimed in claim 1 wherein accessing by a user of the server computer is accomplished by means of a dedicated connection line between the user computer and the server computer.

17. A computer based parking reservation system for making parking reservations through use of a computer network, the system comprising:
a server computer on the computer network for operating a parking reservation program and containing data relating to parking facilities and users thereof;
means within the server computer for receiving and processing data received from users through computers in the computer network relating to a parking space to be reserved at a parking facility at a selected time;
transfer of funds from an account designated by the user to a target account of a parking facility operator; and
a parking reservation confirmation message to the user relating to the parking reservation.

18. A system as claimed in claim 17 wherein the server computer provides different levels of access to information and data according to the nature of the user.

19. A method as claimed in claim 1 wherein the confirmation received comprises a computer screen message thereof.

20. A method for electronically modifying a reservation of a parking space at a parking facility through a computer network, the method comprising the steps of:
accessing by a user communication with a server computer on the computer network, the server computer operating a program for reserving a parking space at a parking facility and containing data relating to a plurality of parking facilities;
identifying a parking facility and the time for which a parking space in the parking facility has previously been made;
modifying previously recorded data relating to the reservation of the parking space in the parking facility;
effecting payment or receiving a refund for the parking space by providing or identifying information to enable the server computer to directly or indirectly transfer funds for the parking reservation between a user designated payment source and a target account; and
receiving confirmation from the server computer that the parking reservation has been modified.
